(19) United States
(12) Patent Application Publication
(10) Pub. No.: US 2001/0042011 A1
(43) Pub. Date: Nov. 15, 2001

(54) Method of doing business using interactive internet interfaces

(76) Inventor: Susan Janet Preston, Springfield, VA (US)

Correspondence Address: DAVID R PRESTON & ASSOCIATES, 12625 HIGH BLUFF DRIVE, SUITE 205, SAN DIEGO, CA, 92130, US

(21) Appl. No.: 09/729,582

(22) Filed: Dec. 4, 2000

Related U.S. Application Data
(60) Provisional application No. 60/172,808, filed on Dec. 21, 1999.

(51) Int. Cl. G06F 17/60

(52) U.S. Cl. 705/14; 705/27

(57) ABSTRACT

The present invention recognizes that traditional holiday customs or beliefs and items can be used as the basis of electronic customs. For example, an Advent Calendar, a traditional Christian Christmas custom and item, can be transformed into an electronic version. The electronic version can be widely distributed on the internet and attract viewers of a particular faith or belief at a particular time of year, such as the days preceding and following Christmas. The attracted viewers are invited to interface with the electronic version of the Advent Calendar. As with traditional Advent Calendars, selected doors are opened on selected days, revealing a treat or gift. In the electronic version, the viewer is invited to select a treat or gift, where additional graphics are optionally provided. Such graphics can include gift ideas, which can be hyperlinked to URL's that have that or similar gifts for sale.

One aspect of the present invention is a method of doing business, including: providing a first URL location with a holiday image or denominational image, inviting a user to select at least a portion of said holiday image or denominational image and linking said user to a second URL. Preferably, such second URL includes a commercial URL.

This application claims benefit of priority to U.S. provisional application Ser. No. 60/172,808, filed Dec. 21, 1999, to Susan Preston, which is incorporated herein by reference in its entirety.

### TECHNICAL FIELD

The present invention generally relates generally to the field of methods of doing business using interactive internet interfaces.

### BACKGROUND

Commerce and advertising has experienced notable changes in the past several years. Advertising and sales continue to become more electronically based as electronics and the internet continue to infuse commerce. Various traditional holiday customs and items have maintained their links to the tangible, such as the Christian advent calendar and the Hebrew Menorah. Despite the increasing commercialization of holiday's, there has yet to be a link between commerce and advertising with such traditional holiday customs and items, particularly in an electronic environment. As commerce and advertising become more competitive on the internet, the need for methods and devices that can attract potential purchasers and viewers is needed. This invention provides these and related benefits.

### SUMMARY

The present invention recognizes that traditional holiday customs or beliefs and items can be used as the basis of electronic customs. For example, an Advent Calendar, a traditional Christian Christmas custom and item, can be transformed into an electronic version. The electronic version can be widely distributed on the internet and attract viewers of a particular faith or belief at a particular time of year, such as the days preceding and following Christmas. The attracted viewers are invited to interface with the electronic version of the Advent Calendar. As with traditional Advent Calendars, selected doors are opened on selected days, revealing a treat or gift. In the electronic version, the viewer is invited to select a treat or gift, where additional graphics are optionally provided. Such graphics can include gift ideas, which can be hyperlinked to URL's that have that or similar gifts for sale.

One aspect of the present invention is a method of doing business, including: providing a first URL location with a holiday image or denominational image, inviting a user to select at least a portion of said holiday image or denominational image and linking said user to a second URL. Preferably, such second URL includes a commercial URL.

### BRIEF DESCRIPTION OF THE FIGURES

FIG. 1A through FIG. 1E depict a series of URL pages for a preferred aspect of the present invention.

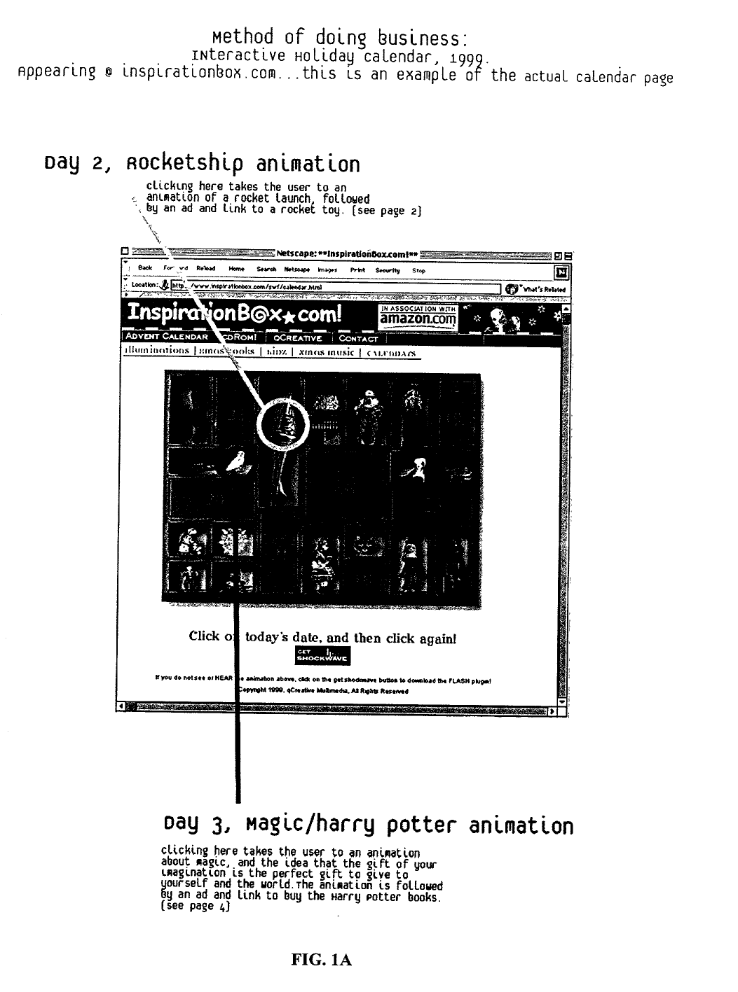

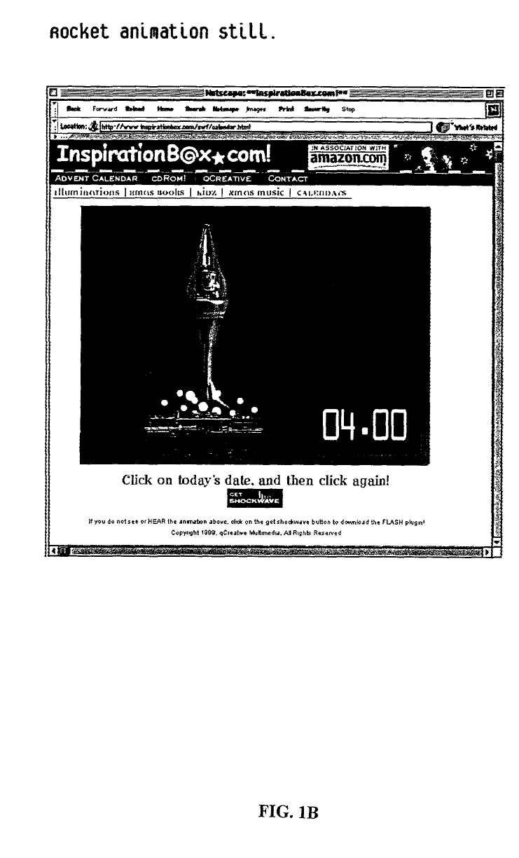

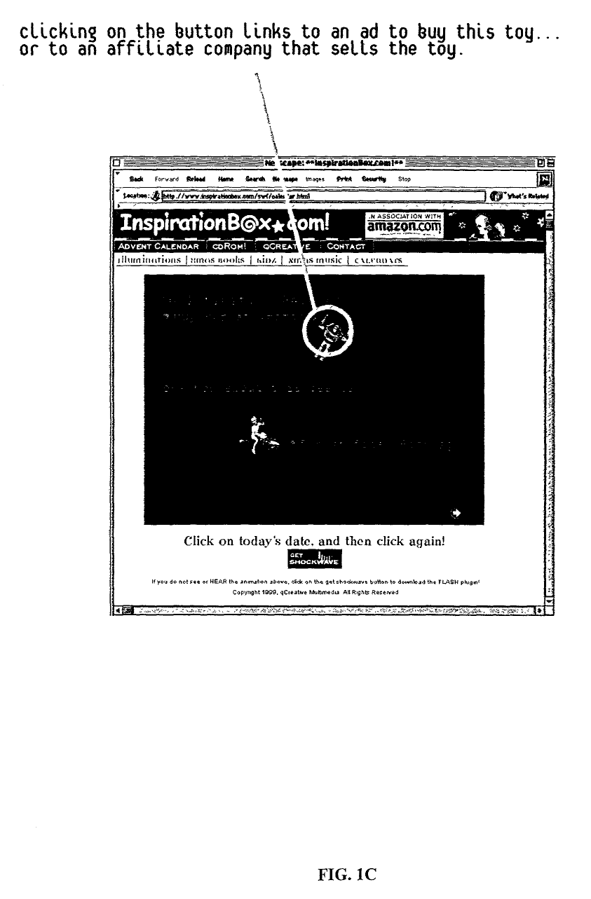

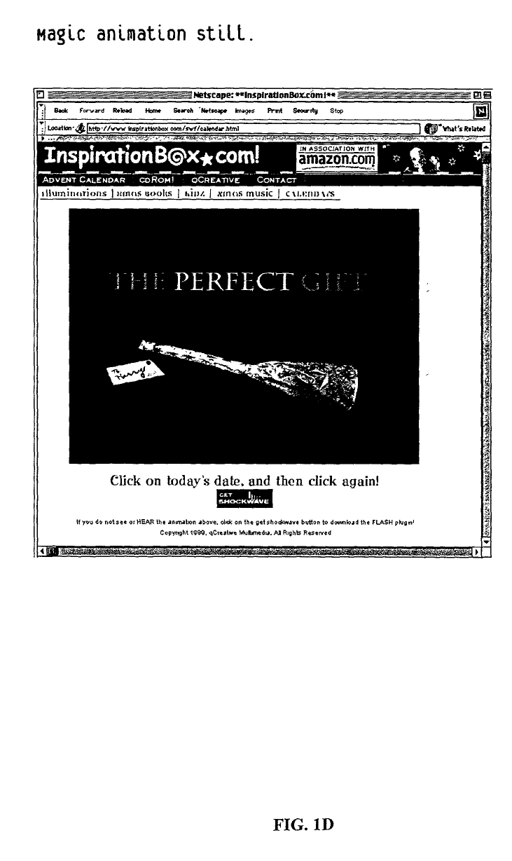

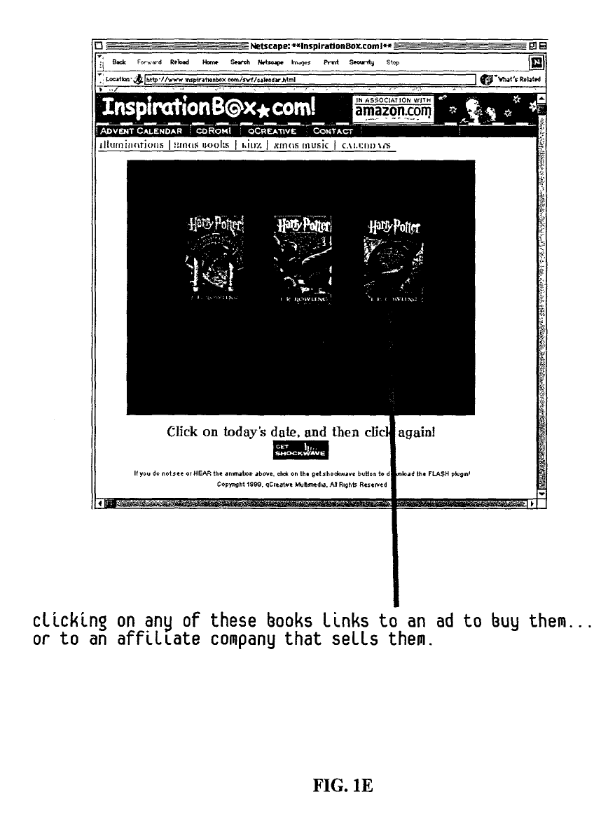

### DETAILED DESCRIPTION OF THE INVENTION

### INTRODUCTION

As a non-limiting introduction to the breath of the present invention, the present invention includes several general and useful aspects, including:

1) a a method of doing business, including: providing a first URL location with a holiday image or denominational image, inviting a user to select at least a portion of said holiday image or denominational image and linking said user to a second URL. Preferably, such second URL includes a commercial URL.

These aspects of the invention, as well as others described herein, can be achieved by using the methods, articles of manufacture and compositions of matter described herein. To gain a full appreciation of the scope of the present invention, it will be further recognized that various aspects of the present invention can be combined to make desirable embodiments of the invention.

### I A METHOD OF DOING BUSINESS USING INTERACTIVE INTERNET INTERFACES

The present invention includes a method of doing business, including: providing a first URL location with a holiday image or denominational image, inviting a user to select at least a portion of said holiday image or denominational image and linking said user to a second URL. Preferably, such second URL includes a commercial URL.

The holiday image or denominational image can be any appropriate image for a target audience or season. For example, a holiday image or denominational image of Christmas can be used for the days, weeks or months preceding and following Christmas. A holiday image can be related to any holiday throughout the world, and a holiday image can optionally be related to a denominational image. A denominational image is linked to a particular denomination, such as Christianity, Judaism, Hindoo or other denomination. One preferred aspect of the present invention provides an image of an advent calendar, Christmas scene or Christmas tree during the Christmas season. Another preferred aspect of the present invention provides a Menorah during the Hanukkah season. Other preferred aspects include, for example, graveyard or haunted house scenes during Halloween season and heart or romantic scenes during Valentines Day season.

The user is invited, directly or indirectly, to select at least a portion of the holiday image or denominational image. Such invitation is inherent in some cases, such as an advent calendar. In other cases, the invitation can be more direct, such as by providing structures. The user can be entertained by having to search for particular a particular locus that will link the user to the next step, such as within the same URL or to another URL.

The user can make such selection using appropriate methods known in the art, such as “clicking” on an internet or internet-TV location. Other methods for selection are known in the art, such as entering a word, number or combination thereof. The user is preferably located at a central processing unit, preferably one linked to the internet. Alternatively, the user can be linked to the internet through an appropriate interfacing device, such as a Set-Top box. The user can enter a selection using an appropriate interfacing method or device, such as a keyboard, location indicator such as a mouse, or a remote control device.

Upon such selection, the user is optionally linked to an entertaining graphic, design or video feed that is preferably related to what was selected. For example, is a space motif was selected, then a space or rocket entertainment graphic, design or video feed results.

Alternatively, the user is taken to a URL the same or different from the first URL that provides gift ideas that are optionally related to the motif originally selected. For example, if a space motif was selected, then a toy, such as Buz Lightyear, would appear or be referenced as a gift suggestion. The user can then select that gift selection and be linked to another (same or different) URL, the second URL. The second URL is preferably a commercial URL that can preferably offer for sale the selected good or selected service. The user can than optionally order the gift. For example, the user can select the Buz Lightyear image, be linked to Amazon.com, which offers for sale a Buz Lightyear plush toy.

Preferably, the user is linked to a URL that is an affiliate of the first URL. In that way, the first URL, and the owner thereof, can be credited with the link of the user from the first URL to the second URL. Such credit can take the form of cash or credit equivalents.

All publications, including patent documents and scientific articles, referred to in this application are incorporated by reference in their entirety for all purposes to the same extent as if each individual publication were individually incorporated by reference.

All headings are for the convenience of the reader and should not be used to limit the meaning of the text that follows the heading, unless so specified.

What is claimed is:

1. A method of doing business, comprising:
a) providing a first URL location with a holiday image or denominational image,
b) inviting a user to select at least a portion of said holiday image or denominational image;
c) linking said user to a second URL,
wherein said second URL comprises a commercial URL.

2. The method of claim 1, further comprising the step of providing said user a gift idea at said first URL location.

3. The method of claim 1, further comprising the step of providing said user a graphic at said first URL.

4. The method of claim 3, wherein said graphic is conceptually linked to the selected holiday image or said denominational image.

5. The method of claim 1, wherein said second URL comprises an catalogue of goods or services.

6. The method of claim 1, wherein said second URL comprises at least one offer for sale of at least one good or at least one service.

7. The method of claim 1, wherein said first URL receives a credit from said second URL for the link of said first URL to said second URL.

8. The method of claim 1, wherein said holiday image or denominational image is a Christian image, a Jewish image, a Buddhist image, a Hindoo image or an Afro-American image.

9. The method of claim 8, wherein said Christian image is a Christmas image.

10. The method of claim 9, wherein said Christmas image is an advent calendar or a Christmas tree.

11. The method of claim 8, wherein said Jewish image is a Menorah.

12. The method of claim 8, wherein said Buddhist image is a temple.

13. The method of claim 8, wherein said Hindoo image is a temple.

14. The method of claim 1, wherein said holiday image or denominational image is Halloween or Valentines day.
